(19) United States
(12) Patent Application Publication
(10) Pub. No.: US 2020/0307180 A1
(43) Pub. Date: Oct. 1, 2020

(54) METHOD OF OPERATING A DROPLET EJECTION DEVICE

(71) Applicant: Canon Production Printing Holding B.V., Venlo (NL)

(72) Inventors: Amol A. KHALATE, Venlo (NL); Koen Joan KLEIN KOERKAMP, Venlo (NL)

(73) Assignee: Canon Production Printing Holding B.V., Venlo (NL)

(21) Appl. No.: 16/900,436

(22) Filed: Jun. 12, 2020

Related U.S. Application Data
(63) Continuation of application No. PCT/EP2018/083214, filed on Nov. 30, 2018.

(30) Foreign Application Priority Data
Dec. 15, 2017 (EP) 17207784.4

(51) Int. Cl. B41J 2/045

(52) U.S. Cl. CPC B41J 2/04508; B41J 2/04586

(57) ABSTRACT

A method of operating a droplet ejection device including an ejection unit arranged to eject droplets of a liquid and including a nozzle formed in a nozzle face, a liquid duct connected to the nozzle, and an electro-mechanical transducer arranged to create an acoustic pressure wave in the liquid in the duct, includes detecting low-viscosity liquid on the nozzle face by analyzing a signal obtained from the transducer.

The invention relates to a method of operating a droplet ejection device comprising an ejection unit arranged to eject droplets of a liquid and comprising a nozzle formed in a nozzle face, a liquid duct connected to the nozzle, and an electro-mechanical transducer arranged to create an acoustic pressure wave in the liquid in the duct.

More particularly, the invention relates to ink jet printing with water-based ink.

The electro-mechanical transducer of an ejection unit of an ink jet printer may for example be a piezoelectric transducer. When a voltage pulse is applied to the transducer, this will cause a mechanical deformation of the transducer. As a consequence, an acoustic pressure wave is created in the liquid ink in the duct, and when the pressure wave propagates to the nozzle, an ink droplet is expelled from the nozzle.

EP 1 378 359 A1 and EP 1 378 360 A1 describe ink jet printers which comprise an electronic circuit for measuring the electric impedance of the piezoelectric transducer. Since the impedance of the transducer is changed when the body of the transducer is deformed or exposed to an external mechanical strain, the impedance can be used as a measure for the reaction forces which the liquid in the duct exerts upon the transducer. Consequently, the impedance measurement can be used for monitoring pressure fluctuations in the ink that are caused by the acoustic pressure wave that is being generated or has been generated by the transducer.

The impedance measurement may be performed in the intervals between successive voltage pulses. In that case, the impedance fluctuations are indicative of the acoustic pressure wave that is gradually decaying in the duct after a droplet has been expelled. This information has been used for example for adapting the amplitude and/or shape of the next voltage pulse.

When a droplet ejection device is operated in a humid atmosphere, the droplet ejection process may be disturbed by water that condenses on the nozzle face. For example, if an ink jet printer operates with water-based ink, the media sheets on which an image has just been printed are frequently heated in order to cure the ink. As a consequence, the water that has been present in the ink will be evaporated and some of the water vapor may condense on the nozzle face, so that the droplet ejection process becomes unstable and the print quality is compromised.

A method according to the preamble of claim 1 is disclosed in US 2012229543 A1.

US 2016368271 A1 discusses problems caused by the condensation of water on the nozzle face.

It is an object of invention to provide a method of operating a droplet ejection device with improved print quality in a humid environment.

In order to achieve this object, the invention proposes the method specified in claim 1.

If condensed water (or another low-viscosity solvent) settles on the nozzle face in the immediate vicinity of the nozzle so that the jetting process will be disturbed, then the ink in the nozzle orifice will become diluted with the water. Since the viscosity of the liquid (ink) depends upon its content of water, and the viscosity of the ink is an important factor influencing the decay pattern of the acoustic wave in the liquid duct, it is possible to monitor the content of water in the liquid by analyzing the waveforms of the acoustic waves detected by the transducer and to stop the jetting process and/or take suitable counter-measures against condensation of water on the nozzle face, if the content of water becomes too high.

In general, the waveform of the acoustic waves in the liquid duct may also be influenced by other factors. If the nozzle face has lost its anti-wetting property, e.g. due to ageing, a pool of ink may form on the nozzle face at the position of the nozzle, so that the meniscus between air and liquid is shifted outwards relative to the nozzle face. Since this changes the volume and the length of the acoustic resonance cavity formed by the liquid duct, the waveform of the acoustic waves decaying after the ejection of the droplet will change. In particular, the frequency of the acoustic waves will decrease. Although the presence of condensed water at the nozzle orifice will generally have a similar effect on the frequency of the acoustic waves, the case where the decrease in frequency is caused by a pool of ink can be discriminated from the case where the decrease is caused by condensed water by analyzing other parameters of the waveform. A pool of ink on the nozzle face will cause a larger decrease in the amplitude of the acoustic wave than condensed water. Moreover, an acoustic wave that propagates only in the liquid (ink) having a high viscosity will be dampened faster than an acoustic wave propagating in a liquid that is diluted with water. Consequently, a slow dampening of the acoustic waves, i.e. a large decay time constant, is a reliable indicator for the presence of a low-viscosity liquid such as water on the nozzle face.

Distinguishing between the cases where the change in the waveform of the acoustic wave is caused by ink on the one hand and by water on the other hand, permits to take specific counter-measures. For example, if condensed water is detected, appropriate counter-measures might comprise heating the nozzle face or increasing the spacings between the media sheets that are conveyed past the print head, thereby to increase the time intervals in which the nozzle face is not exposed to a high concentration of water vapor so that the condensed water on the nozzle face as time to evaporate again. On the other hand, if a pool of ink is detected on the nozzle face, it would be more appropriate to interrupt the print process in order to wipe the nozzle face.

There has also been proposed a printing method in which the nozzle face gets wetted by the ink, so that an ink pool is formed on purpose. Then, however, it is necessary to control the depth of the ink pool by appropriately controlling the pattern of the actuating pulses applied to the transducer. Conceivably, a printing process of this type is particularly sensitive to condensation of water vapor on the nozzle face because the ink pool is likely to become diluted with water. The method according to the invention is therefore particularly beneficial for a print process operating with a controlled ink pool on the nozzle face.

Useful details and further developments of the invention are indicated in the dependent claims.

Embodiment examples of the invention will now be described in conjunction with the drawings, wherein:

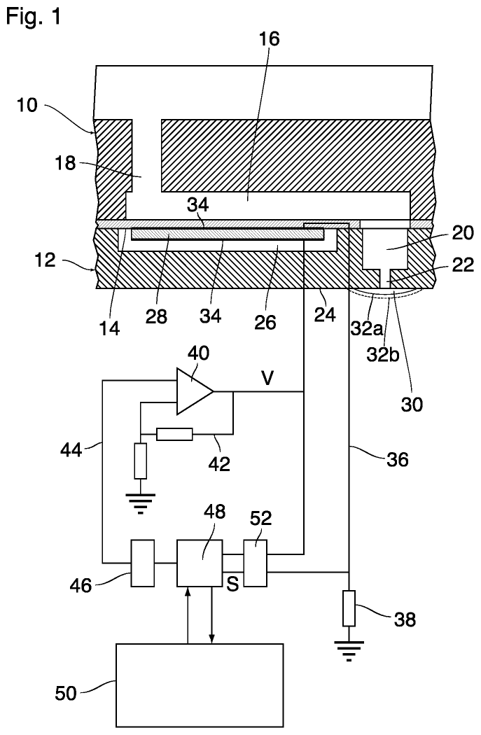

FIG. 1 is a cross-sectional view of mechanical parts of a droplet ejection device according to the invention, together with an electronic circuit for controlling and monitoring the device;

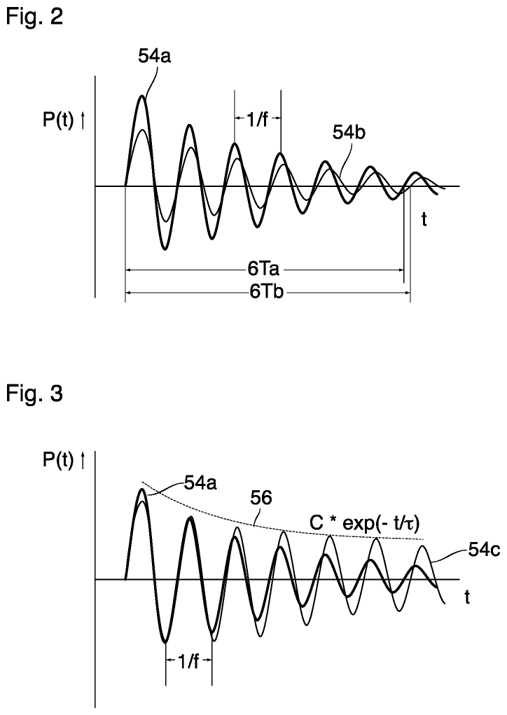

FIG. 2 is a time diagram illustrating waveforms of acoustic pressure waves in a liquid duct of the droplet ejection device;

FIG. 3 is a time diagram illustrating a waveform obtained in case that condensed water is present on a nozzle face of the droplet ejection device;

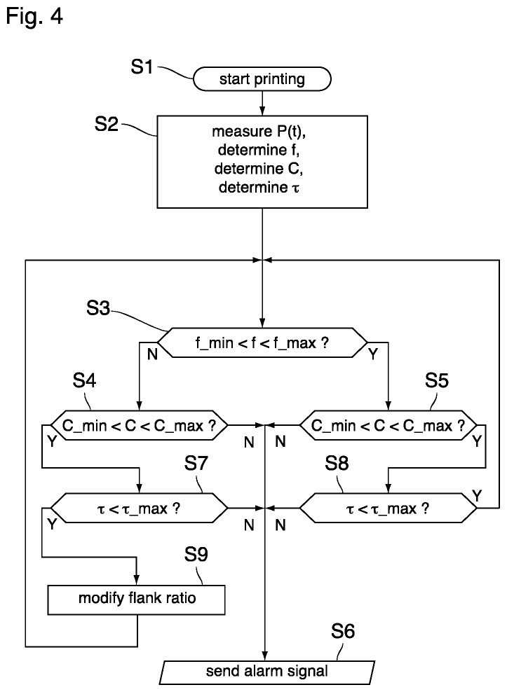

FIG. 4 is a flow diagram showing essential steps of a method according to an embodiment of the invention; and

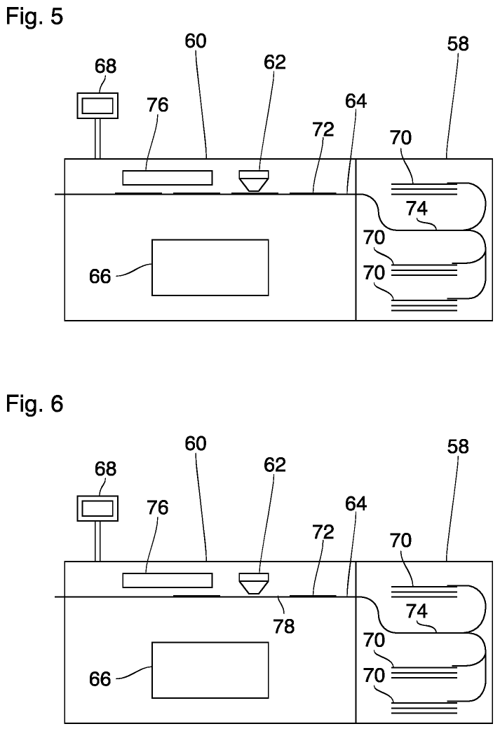

FIGS. 5 and 6 show a printing system in two different operational states.

A single ejection unit of an ink jet print head has been shown in FIG. 1. The print head constitutes an example of a droplet ejection device according to the invention. The device comprises a wafer 10 and a support member 12 that are bonded to opposite sides of a thin flexible membrane 14.

A recess that forms an ink duct 16 is formed in the face of the wafer 10 that engages the membrane 14, e.g. the bottom face in FIG. 1. The ink duct 16 has an essentially rectangular shape. An end portion on the left side in FIG. 1 is connected to an ink supply line 18 that passes through the wafer 10 in thickness direction of the wafer and serves for supplying liquid ink to the ink duct 16.

An opposite end of the ink duct 16, on the right side in FIG. 1, is connected, through an opening in the membrane 14, to a chamber 20 that is formed in the support member 12 and opens out into a nozzle 22 that is formed in a nozzle face 24 constituting the bottom face of the support member.

Adjacent to the membrane 14 and separated from the chamber 20, the support member 12 forms another cavity 26 accommodating a piezoelectric actuator 28 that is bonded to the membrane 14.

An ink supply system which has not been shown here keeps the pressure of the liquid ink in the ink duct 16 slightly below the atmospheric pressure, so as to prevent the ink from leaking out through the nozzle 22.

The nozzle face 24 is made of or coated with a material which is wetted by the ink, so that adhesion forces cause a pool 30 of ink to be formed on the nozzle face 24 around the nozzle 22. The pool 30 is delimited on the outward (bottom) side by a meniscus 32a.

The piezoelectric transducer 28 has electrodes 34 that are connected to an electronic circuit that has been shown in the lower part of FIG. 1. In the example shown, one electrode of the transducer is grounded via a line 36 and a resistor 38. Another electrode of the transducer is connected to an output of an amplifier 40 that is feedback-controlled via a feedback network 42, so that a voltage V applied to the transducer will be proportional to a signal on an input line 44 of the amplifier. The signal on the input line 44 is generated by a D/A-converter 46 that receives a digital input from a local digital controller 48. The controller 48 is connected to a processor 50.

When an ink droplet is to be expelled from the nozzle 22, the processor 50 sends a command to the controller 48 which outputs a digital signal that causes the D/A-converter 46 and the amplifier 40 to apply an actuation pulse to the transducer 28. This voltage pulse causes the transducer to deform in a bending mode. More specifically, the transducer 28 is caused to flex downward, so that the membrane 14 which is bonded to the transducer 28 will also flex downward, thereby to increase the volume of the ink duct 16. As a consequence, additional ink will be sucked-in via the supply line 18. Then, when the voltage pulse falls off again, the membrane 14 will flex back into the original state, so that a positive acoustic pressure wave is generated in the liquid ink in the duct 16. This pressure wave propagates to the nozzle 22 and causes an ink droplet to be expelled. The pressure wave will then be reflected at the meniscus 32a and will oscillate in the cavity formed between the meniscus and the left end of the duct 16 in FIG. 1. The oscillation will be dampened due to the viscosity of the ink. Further, the transducer 28 is energized with a quench pulse which has a polarity opposite to that of the actuation pulse and is timed such that the decaying oscillation will be suppressed further by destructive interference.

The electrodes 34 of the transducer 28 are also connected to an A/D converter 52 which measures a voltage drop across the transducer and also a voltage drop across the resistor 38 and thereby implicitly the current flowing through the transducer. Corresponding digital signals S are forwarded to the controller 48 which can derive the impedance of the transducer 28 from these signals. The measured electric response (current, voltage, impedance, etc.) is signaled to the processor 50 where the electric response is processed further.

FIG. 2 shows a typical waveform 54a of a pressure fluctuation decaying in the ink duct 16, the pressure fluctuations being represented by a function P(t) of the time t. The electronic circuit shown in FIG. 1 is capable of measuring the response of the transducer 28 to these pressure fluctuations, so that the processor 50 may record and analyze the function P(t).

The frequency f of the pressure fluctuations depends upon the density and viscosity of the liquid ink and also on the dimensions of the resonance cavity. If the pool 30 becomes larger, so that it is delimited by a meniscus 32b shown in dashed lines in FIG. 1, then the frequency of the pressure fluctuations will be slightly lower, as shown by the waveform 54b in FIG. 2. In order to visualize the difference in the frequencies of the waveforms 54a and 54b in FIG. 2, the time intervals 6Ta and 6Tb, which correspond to six times the period T of the respective waveform have been shown in this figure.

Further, due to the increased mass of the oscillating ink volume, the amplitude of the pressure fluctuations and, consequently, their total energy content becomes smaller. Thus, it is possible to infer the depth of the ink pool 30 from the characteristic parameters, in particular frequency f and amplitude or energy, of the waveform 54a or 54b currently detected by the transducer.

In order to obtain a stable droplet ejection behavior of the device, it is essential that the depth of the pool 30 is kept constant. It shall be assumed here that the waveform 54a shown in FIG. 3 corresponds to a target depth of the pool 30. If a deviation in the frequency shows that the depth of the pool has become too large, as represented by the waveform 54b, the controller changes the shape of the actuation pulses applied to the actuator. These pulses may be asymmetric in the sense that the height of the rising flank is smaller than the height of the descending flank or, in other words, the flank ratio is smaller than 1. This asymmetry is compensated by a corresponding asymmetry in the subsequent quench pulse. The effect of the asymmetry of the actuation pulse is that less ink is drawn in during the rising flank and more ink is squeezed out through the nozzle 22 during the descending flank. The major part of this increased amount of ink will be consumed by the generation of the ink droplet. When the membrane 14 returns to the non-deflected state at the end of the quench pulse, there will be a deficit of ink in the ink duct, and ink will be withdrawn from the pool 30 into the ink duct, so that the pool 30 will shrink and its depth will decrease. In this way, the depth of the pool is returned to the target value.

Conversely, if an increase in the frequency of the pressure fluctuations shows that the depth of the pool 30 has become too small, the shape of the actuation pulse will be modified such that the flank ratio becomes larger than 1, so that excessive ink will be pumped in the pool 30 and the pool will grow again.

The asymmetries in the actuation pulses may be controlled such their influence on the size of the ejected ink droplets is negligible but the depth of the pool 30 can nevertheless be returned to the target value in a few ejection cycles.

In certain applications, such as a printing application with water-based ink, an increased production of water vapor in the vicinity of the droplet ejection device 10 may result in condensation of water on the nozzle face 24. This may have the consequence that the pool 30 formed at the nozzle 22 does not consist only of ink with a high viscosity but instead consists mainly of water which has a significantly lower viscosity. This results in a modified waveform 54c of the pressure fluctuations, as has been shown in FIG. 3. For comparison, the “regular” waveform 54a has also been shown in FIG. 3.

It can be seen in FIG. 3 that the pool of water causes essentially the same decrease in the frequency f as the pool of ink, but, due to the lower viscosity (and density) of the water, the amplitude and energy of the pressure fluctuations are higher than in case of the waveform 54b (FIG. 2), so that the initial amplitude is almost as high as for the waveform 54a. Moreover, the lower viscosity of the water has the effect that the pressure fluctuations are dampened more slowly. A dashed line 56 in FIG. 3 is an envelope of the waveform 54c and corresponds approximately to the graph of an exponential decay function C·exp(−t/τ), wherein C is a constant (indicating the initial amplitude of the fluctuation), and τ is the decay time constant. As is shown in FIG. 3, the decay of the waveform 54c is much slower than that of the waveform 54a, which means that the waveform 54c has a significantly larger decay time constant τ.

Consequently, the criteria: “high amplitude” and “slow decay” can be taken as an indication for the presence of a significant amount of water in the pool 30. So, the processor 50 can also detect an unacceptably large amount of water in the pool 30 and can stop the droplet ejection process (print process) if the content of water becomes intolerable.

FIG. 4 is a flow diagram illustrating essential steps of an example of a method according to the invention.

The ink jet print head starts printing at step S1. It will be understood that the print head has a plurality of nozzle and actuator arrangements of the type shown in FIG. 1, and the subsequent steps to be described below will be performed separately for each pair of nozzle and actuator.

In step S2, the processor 50 measures the function P(t) representing the pressure fluctuations and determines the frequency f of the recorded waveform as well as the parameters C and τ of the corresponding decay function.

In step S3, it is checked whether the frequency f is within an admissible frequency range defined by a lower limit f_min and an upper limit f_max. If the result is positive (Y) in step S3, this means that the depth of the pool 30 is sufficiently close to the target value, so that the print process can be continued with the present shape of the actuation and quench pulses.

Regardless of the outcome of step S3, it is checked in steps S4 and S5 whether the parameter C, which is a measure of the amplitude or energy of the pressure fluctuations, is also within an admissible range defined by a lower limit C_min and an upper limit C_max. As has been shown in FIGS. 2 and 3, the parameter C should decrease significantly with decreasing frequency f if the pool 30 consists mainly of ink, whereas C will be larger if the pool contains water. Thus, the upper limit C_max is selected so as to discriminate between the case where the pool 30 consists mainly of ink, as desired, and the case where the pool contains an inacceptable amount of water, resulting in a higher value C. The comparison of the parameter C with the lower limit C_min is optional and may serve to detect any other types of malfunction.

If it is found in step S4 or S5 that the parameter C is not within the admissible range (N), an error signal is generated in step S6. The error signal may shut down the printer and/or may prompt an operator to take suitable counter-measures or may trigger such counter-measures automatically, as will be described later.

In a simple implementation, the limit C_max may be constant. It will be observed however, that the amplitude of the pressure fluctuations will decrease with increasing depth of the pool 30 and, consequently, will decreasing frequency f. Therefore, in a more elaborated embodiment, the upper limit C_max of the amplitude range may be made dependent upon the detected frequency f.

If the result in step S4 or S5 has been “yes” (Y), it is checked in step S7 and S8, respectively, whether the decay time constant i is below a certain upper limit τ_max. If this is not the case (N), this is an indication that the amount of water in the pool is too high, and, again, an error signal is issued in step S6.

Otherwise, if the results have been “yes” (Y) in step S3 and also in steps S5 and S8, it can be concluded that the pool 30 is in the desired condition, and the process loops back to step S3, while the print process is continued without any modifications.

In a practical embodiment, the loop constituted by the steps S3, S5 and S8 may be repeated every 100 ms, for example.

If a negative result (N) had been obtained in step S3 and positive results (Y) have been obtained in steps S4 and S7, this means that the water content of the pool 30 is acceptable but the depth of the pool differs significantly from the target value. Consequently, the flank ratio of the actuation pulses is modified in step S9 in order to restore the target depth of the pool 30, where after the process loops back to step S3 again.

The invention is not limited to a print process where an ink pool is formed on the nozzle face and the depth of the ink pool is controlled. Condensed water may also be a problem in a print process in which the nozzle face has an anti-wetting coating and the ink/air meniscus is formed inside the nozzle orifice. In that case, condensed water can still dilute the ink in the nozzle orifice, which may be detrimental to the print process. However, the dilution of the ink in the nozzle orifice has a similar effect on the waveform of the pressure waves as has been described above, in particular on the decay time constant t, so that the presence of water or other low-viscosity liquids can still be detected.

FIG. 5 shows an example of a printing system that comprises an input section 58 and a main body 60. The main body 60 comprises a print head 62 disposed at a sheet transport path 64, an electronic control unit 66 and a user interface 68.

The control unit 66 is connected to all the functional components of the printing system, including the electronic circuits (FIG. 1) associated with the ejection units of the print head 62, and is further connected to the user interface 68.

The input section 58 includes a plurality of holders 70 each of which accommodates a supply, e.g. a stack, of media sheets 72 of a certain media type. The input section 58 further includes a feed mechanism 74 arranged to separate individual sheets 72 from a selected one of the holders 70 and to supply them one by one into the sheet transport path 64.

When the print process has been started, the control unit 66 controls the feed mechanism 74 to supply the sheets in the sequence as scheduled into the sheet transport path 64, and it controls the print head 62 so as to print an image on the top side of each sheet.

It is assumed here that the print head 62 is an ink jet print head operating with water-based ink. The sheets 72 that have moved past the print head and have received an image are heated by means of a heater 76 in order to cure the ink before the sheets are discharged. In the curing process, most of the water that was contained in the ink will evaporate, so that a humid atmosphere is created in the environment of the print head 62. As a result, condensed water may form in the nozzle face of the print head.

When the processor or processors 50 associated with the individual ejection units of the print head 62 send signals indicating the presence of condensed water at at least a certain number of the nozzles 22, the control unit 66 instructs the feed mechanism 74 to reduce the frequency with which the sheets 72 are fed into the sheet transport path 64, so that the sheets 72 are separated by larger gaps 78, as has been shown in FIG. 6. This has the effect that the evaporation rate of water is reduced and the water that has condensed on the nozzle face may evaporate again before the next sheet 72 arrives at the print head 62, so that a high print quality can be assured and the print process may be continued. As an alternative, the speed with which the sheets are conveyed through the transport path 64 may be reduced.

Since the condensation of water on the nozzle face can be monitored continuously, the production rate of the printer can automatically be adapted to the amount of condensed water on the nozzle face, even when operating conditions such as the temperature of the print head change.

1. A method of operating a droplet ejection device comprising an ejection unit arranged to eject droplets of an ink and comprising a nozzle formed in a nozzle face, a liquid duct connected to the nozzle, and an electro-mechanical transducer arranged to create an acoustic pressure wave in the liquid in the duct,
said method comprising the steps of:
detecting a first case where condensed water is present in a pool on the nozzle face at a position of the nozzle and discriminating the first case from a second case where the pool is formed by ink, the step of detecting comprising analyzing a decay time constant and an amplitude of acoustic pressure fluctuations decaying in the liquid duct after the ejection of a droplet, the pressure fluctuations causing a response of the transducer and being represented by a signal obtained from the transducer; and
issuing an error signal in the first case where condensed water is present in the pool.

2. The method according to claim 1, wherein the step of detecting comprises a step of analyzing a frequency of pressure fluctuations decaying in the duct after ejection of a droplet, the pressure fluctuations causing a response of the transducer.

3. A droplet ejection device comprising:
a number of ejection units arranged to eject droplets of a liquid and each comprising a nozzle formed in a nozzle face;
a liquid duct connected to the nozzle; and
an electro-mechanical transducer arranged to create an acoustic pressure wave in the liquid in the duct,
wherein at least one of the number of ejection units is associated with a processor configured to perform the method according to claim 1.

4. The droplet ejection device according to claim 3, configured for ink jet printing with water-based ink.

5. A printing system comprising:
the droplet ejection device according to claim 3 as an ink jet print head;
a sheet transport path for conveying media sheets past the print head;
a feed mechanism arranged for feeding the sheets into the sheet transport path; and
a control unit configured to reduce a rate with which the sheets are fed to the print head when the presence of condensed water on the nozzle face is detected by at least a predetermined number of ejection units of the print head.

6. A software product comprising program code on a machine-readable non-transitory medium, the program code, when loaded into a processor of a droplet ejection device, comprising a number of ejection units arranged to eject droplets of a liquid and each comprising a nozzle formed in a nozzle face; a liquid duct connected to the nozzle; and an electro-mechanical transducer arranged to create an acoustic pressure wave in the liquid in the duct, causes the processor to perform the method according to claim 1.

7. A software product comprising program code on a machine-readable non-transitory medium, the program code, when loaded into a control unit of the printing system according to claim 5, causes the control unit to reduce the rate with which the sheets are fed to the print head when the presence of condensed water on the nozzle face is detected by at least a predetermined number of ejection units of the print head.
